(19) United States
(12) Patent Application Publication
(10) Pub. No.: US 2025/0063476 A1
(43) Pub. Date: Feb. 20, 2025

(54) CONFIGURATION FOR ON-DEMAND SIB1

(71) Applicant: Samsung Electronics Co., Ltd., Suwon-si (KR)

(72) Inventors: Hongbo Si, Allen, TX (US); Anil Agiwal, Allen, TX (US); Jeongho Jeon, San Jose, CA (US)

(21) Appl. No.: 18/793,621

(22) Filed: Aug. 2, 2024

Related U.S. Application Data
(60) Provisional application No. 63/533,298, filed on Aug. 17, 2023.
(60) Provisional application No. 63/632,281, filed on Apr. 10, 2024.
(60) Provisional application No. 63/674,068, filed on Jul. 22, 2024.

(51) Int. Cl. H04W 48/14

(52) U.S. Cl. CPC H04W 48/14

(57) ABSTRACT

Methods and apparatuses for an operation for configurations for on-demand SIB1 in a wireless communication system is provided. A method of a user equipment (UE) includes receiving, from a cell of a first base station (BS), a first synchronization signals and physical broadcast channel (SS/PBCH) block; determining, based on an indication in a physical broadcast channel (PBCH) of the first SS/PBCH block, a first value of k_{SSB}; and determining, based on the first value of k_{SSB}, whether the cell is associated with an on-demand system information block 1 (SIB1). The method further includes transmitting, based on a determination that the cell is associated with the on-demand SIB1, a request for the on-demand SIB1 to a second BS and receiving the on-demand SIB1.

### CROSS-REFERENCE TO RELATED APPLICATIONS AND CLAIM OF PRIORITY

The present application claims priority to:
U.S. Provisional Patent Application No. 63/533,298, filed on Aug. 17, 2023;
U.S. Provisional Patent Application No. 63/632,281, filed on Apr. 10, 2024; and
U.S. Provisional Patent Application No. 63/674,068, filed on Jul. 22, 2024.
   The contents of the above-identified patent documents are incorporated herein by reference.

### TECHNICAL FIELD

The present disclosure relates generally to wireless communication systems and, more specifically, the present disclosure relates to configurations for an on-demand system information block 1 (SIB1) in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to an operation for configurations for an on-demand SIB1 in a wireless communication system.

In one embodiment, a user equipment (UE) in a wireless communication system is provided. The UE includes a transceiver configured to receive, from a cell of a first base station (BS), a first synchronization signals and physical broadcast channel (SS/PBCH) block and a processor operably coupled to the transceiver. The processor is configured to determine, based on an indication in a physical broadcast channel (PBCH) of the first SS/PBCH block, a first value of k_{SSB} and determine, based on the first value of k_{SSB}, whether the cell is associated with an on-demand SIB1. The transceiver is further configured to transmit, based on a determination that the cell is associated with the on-demand SIB1, a request for the on-demand SIB1 to a second BS and receive the on-demand SIB1.

In another embodiment, a method of a UE in a wireless communication system is provided. The method includes receiving, from a cell of a first BS a first SS/PBCH block; determining, based on an indication in a PBCH of the first SS/PBCH block, a first value of k_{SSB}; and determining, based on the first value of k_{SSB}, whether the cell is associated with an on-demand SIB1. The method further includes transmitting, based on a determination that the cell is associated with the on-demand SIB1, a request for the on-demand SIB1 to a second BS and receiving the on-demand SIB1.

In yet another embodiment, a BS in a wireless communication system is provided. The BS includes a processor configured to determine whether a cell is associated with an on-demand SIB1 and determine a first value of k_{SSB} when the cell is associated with the on-demand SIB1. The BS further includes a transceiver operably coupled to the processor. The transceiver is configured to transmit, to a UE, a first SS/PBCH block; receive, from another BS, an indication for transmitting the on-demand SIB1; and transmit, to the UE, the on-demand SIB1 in the cell. A PBCH in the first SS/PBCH block indicates the first value of k_{SSB}.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of SS/PBCH block structure according to embodiments of the present disclosure;

FIG. 7 illustrates an example of procedure for on-demand SSB/SIB1 according to embodiments of the present disclosure;

FIG. 8 illustrates a flowchart of UE method for receiving on-demand SIB1 according to embodiments of the present disclosure;

FIG. 9 illustrates an example of k_SSB switching according to embodiments of the present disclosure; and

FIG. 10 illustrates an example method performed by a UE in a wireless communication system according to embodiments of the present disclosure.

### DETAILED DESCRIPTION

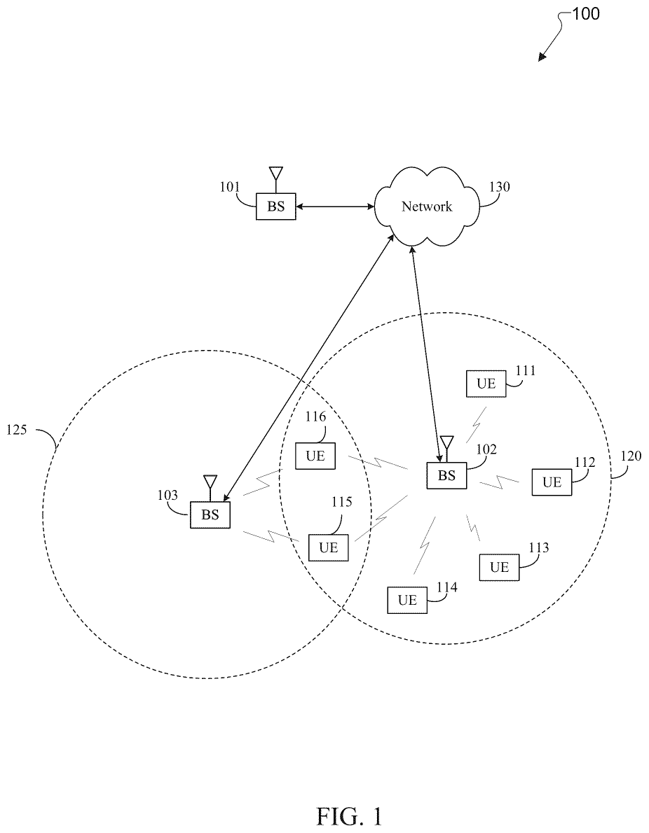

FIGS. 1-9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and channel coding”; 3GPP TS 38.213 v16.1.0, “NR; Physical layer procedures for control”; 3GPP TS 38.214 v16.1.0, “NR; Physical layer procedures for data”; and 3GPP TS 38.331 v16.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for identifying and using configurations for an on-demand SIB1 in a wireless communication system. In certain embodiments, and one or more of the gNBs 101-103 includes circuitry, programing, or a combination thereof, for supporting configurations for an on-demand SIB1 in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

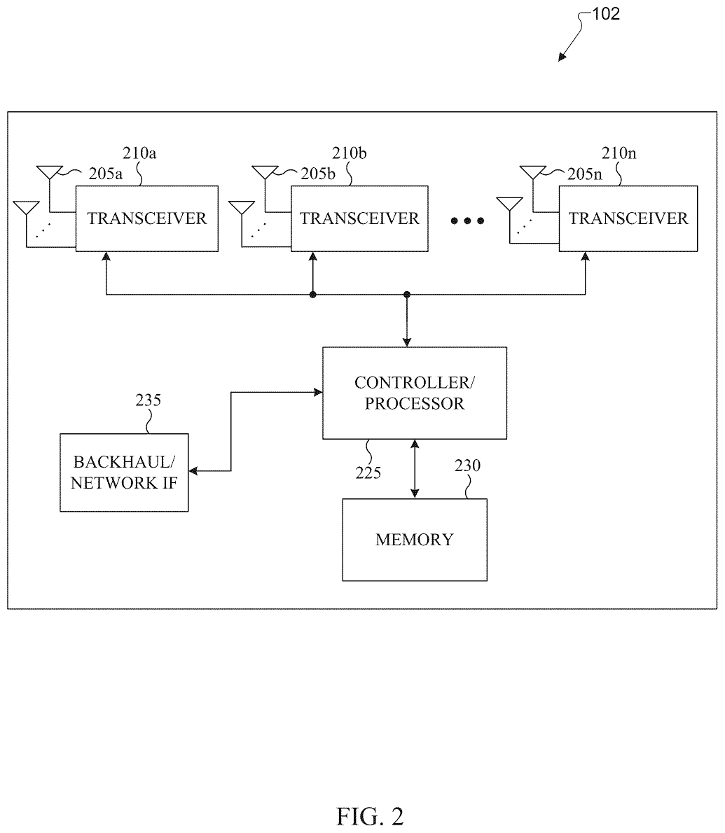

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting configurations for an on-demand SIB1 in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

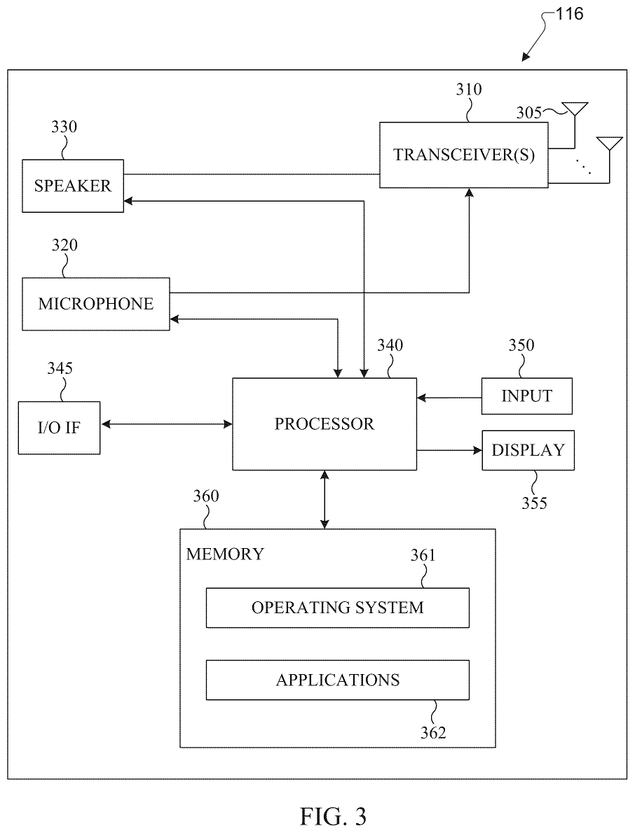

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes identifying and utilizing configurations for an on-demand SIB1 in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

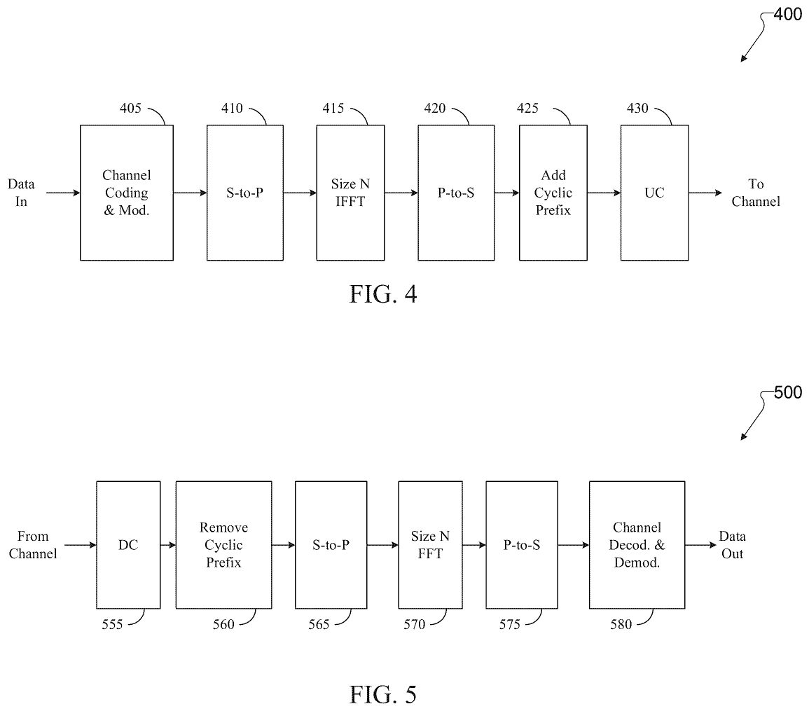

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support configurations for an on-demand SIB1 in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

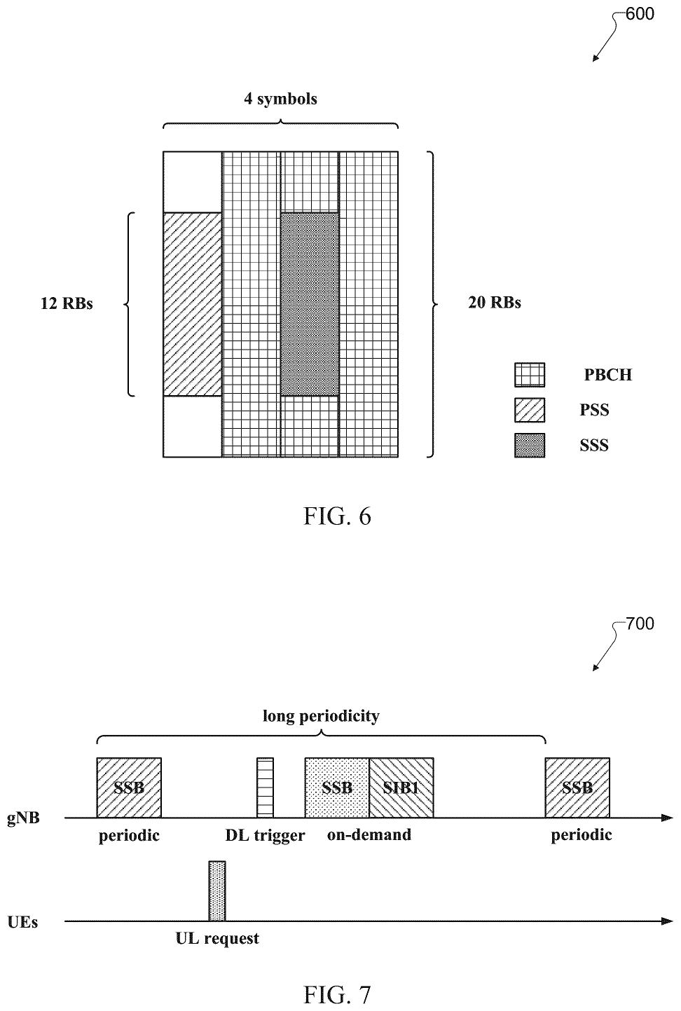

FIG. 6 illustrates an example of SS/PBCH block structure 600 according to embodiments of the present disclosure. An embodiment of the SS/PBCH block structure 600 shown in FIG. 6 is for illustration only.

NR supports synchronization through synchronization signals transmitted on downlink. A synchronous signal/physical broadcast physical channel block (SSB) compromises of four consecutive OFDM symbols in time domain (e.g., as illustrated in FIG. 6), wherein the first symbol is mapped for primary synchronization signal (PSS), the second and forth symbols are mapped for PBCH, and the third symbol is mapped for both secondary synchronization signal (SSS) and PBCH. The transmission bandwidth of PSS and SSS (e.g., 12 resource blocks (RBs)) is smaller than the transmission bandwidth of the whole SS/PBCH block (e.g., 20 RBs). In every RB mapped for PBCH, 3 out of the 12 resource elements (REs) are mapped for the demodulation reference signal (DMRS) of PBCH, wherein the 3 REs are uniformly distributed in the RB and the starting location of the first RE (e.g., v as in TABLE 1) is based on cell ID.

TABLE 1
Resource mapping within a S-SS/PSBCH block.

| Signal or channel | Symbol index | Subcarrier index |
|---|---|---|
| S-PSS | 0 | 56, 57, . . . , 182 |
| S-SSS | 2 | 56, 57, . . . , 182 |
| Set to | 0 | 0, 1, . . . , 55, 183, |
| zero | | 184, . . . , 239 |
| | 2 | 48, 49, . . . , 55, |
| | | 183, 184, . . . , 191 |
| PSBCH | 1, 3 | 0, 1, . . . , 239 |
| | 2 | 0, 1, . . . , 47, |
| | | 192, 193, . . . , 239 |
| DM-RS | 1, 3 | 0 + v, 4 + v, . . . , |
| for PSBCH | | 236 + v |
| | 2 | 0 + v, 4 + v, . . . , 44 + v, |
| | | 192 + v, 196 + v, . . . , |
| | | 236 + v, |

An SS/PBCH block is transmitted on a cell periodically, with a periodicity configured by a gNB. As an always-present transmission, the power consumption for SS/PBCH block (SSB) in a cell can be significantly large. To reduce the power consumption, the periodicity of SSB can be large, which may result in long delay for receiving the SSB, if a UE needs to receive a SSB on a timing within the long period for SSB. For this purpose, on-demand SSB can be supported, e.g., in addition to the periodic SSB, to reduce the latency for receiving the SSB.

For this purpose, for example, a UE can transmit an uplink request for configurations on-demand SSB and/or SIB1, and the UE may receive a downlink trigger for the on-demand SSB and/or SIB1, before the reception of the on-demand SSB and/or SIB1. For this example, the procedure for uplink request and/or downlink trigger can be absent, in certain exemplified cases of this disclosure. An illustration of this example is shown in FIG. 7.

FIG. 7 illustrates an example of procedure for on-demand SSB/SIB1 700 according to embodiments of the present disclosure. An embodiment of the procedure for on-demand SSB/SIB1 700 shown in FIG. 7 is for illustration only.

The configurations for the on-demand SIB1 may not follow the configurations of the legacy SIB1, since the time, frequency, and power domain resources for the on-demand SIB1 can be more flexible.

The present disclosure focuses on a design for configuring an on-demand SIB1. More precisely, the following components are included in the disclosure: (1) an indication of the presence of the on-demand SIB1, (2) an indication of the subcarrier spacing (SCS) of the on-demand SIB1, (3) control resource set (CORESET) #0 configuration for the on-demand SIB1, (4) Type0-PDCCH configuration for the on-demand SIB1, (5) examples of UE procedure, and (6) k_SSB for the on-demand SIB1.

In one embodiment, a UE can determine whether to receive an on-demand SIB1 (e.g., whether a CORESET #0 for monitoring PDCCH that schedules on-demand SIB1 is present, or whether the cell is associated with on-demand SIB1 for reception). At least one of the examples can be used for indicating whether to receive an on-demand SIB1 (e.g., whether a CORESET #0 for monitoring PDCCH that schedules on-demand SIB1 is present, or whether the cell is associated with on-demand SIB1 for reception), including combination(s) of the examples. The indication can also be using multiple methods, wherein at a time instance, the indication is using one method within the multiple methods.

In one example, the presence of the on-demand SIB1 (e.g., the presence of a CORESET #0 for monitoring PDCCH that schedules on-demand SIB1, or the cell is associated with on-demand SIB1 for reception) is bundled with the presence of an on-demand SSB. A UE can assume a CORESET #0 for monitoring PDCCH that schedules on-demand SIB1 is associated with an on-demand SSB, e.g., a CORESET #0 for monitoring PDCCH that schedules on-demand SIB1 is present if its associated on-demand SSB is present.

In another example, the presence of the on-demand SIB1 (e.g., the presence of a CORESET #0 for monitoring PDCCH that schedules on-demand SIB1, or whether the cell is associated with on-demand SIB1 for reception) can be indicated by the DL trigger that triggers (or indicates) the transmission of on-demand SSB and/or on-demand SIB1. For one instance, the indication can be an explicit field in the DL trigger. For another instance, the indication can be in an implicit way that the presence of the configuration for the DL trigger, and/or the presence of the transmission/reception of the DL trigger implies the transmission of on-demand SSB and/or on-demand SIB1.

In yet another example, the presence of the on-demand SIB1 (e.g., the presence of a CORESET #0 for monitoring PDCCH that schedules on-demand SIB1, or whether the cell is associated with on-demand SIB1 for reception) can be indicated by the UL trigger that triggers the transmission of on-demand SSB and/or on-demand SIB1. For one instance, the indication can be an explicit field in the UL trigger. For another instance, the indication can be in an implicit way that the presence of the configuration for the UL trigger, and/or the presence of the transmission/reception of the UL trigger implies the transmission of on-demand SSB and/or on-demand SIB1.

In yet another example, the presence of the on-demand SIB1 (e.g., the presence of a CORESET #0 for monitoring PDCCH that schedules on-demand SIB1, or whether the cell is associated with on-demand SIB1 for reception) can be indicated by higher layer parameters. For one instance, the higher layer parameters can include system information from a gNB that does not perform the transmission of on-demand SSB or on-demand SIB1 (e.g., the system information may include other configurations on the on-demand SSB or the on-demand SIB1 as well). For another instance, the higher layer parameters can include system information from a gNB that performs the transmission of on-demand SSB or on-demand SIB1 (e.g., the system information may include other configurations on the on-demand SSB or the on-demand SIB1 as well).

In yet another example, the presence of the on-demand SIB1 (e.g., the presence of a CORESET #0 for monitoring PDCCH that schedules on-demand SIB1, or whether the cell is associated with on-demand SIB1 for reception) can be indicated by a SSB, e.g., the associated on-demand SSB, and/or the associated SSB on the same cell.

For one instance, the UE can determine whether a CORESET #0 for monitoring PDCCH that schedules on-demand SIB1 is present (or whether the cell is associated with on-demand SIB1 for reception) based on a value of k_SSB of the SSB.

For one instance, for a frequency range (FR) 1, if k_SSB<24, then its associated CORESET #0 for monitoring PDCCH that schedules on-demand SIB1 is present.

For another instance, for FR2, if k_SSB<12, then its associated CORESET #0 for monitoring PDCCH that schedules on-demand SIB1 is present.

For another instance, the UE can determine whether a CORESET #0 for monitoring PDCCH that schedules on-demand SIB1 is present (or whether the cell is associated with on-demand SIB1 for reception) based on a value of k_SSB and the reserved bit in PBCH payload (e.g., spare).

For one instance, for FR1, if k_SSB<24, and the reserved bit in PBCH payload takes a particular value (e.g., 1), then its associated CORESET #0 for monitoring PDCCH that schedules on-demand SIB1 is present.

For another instance, for FR2, if k_SSB<12, and the reserved bit in PBCH payload takes a particular value (e.g., 1), then its associated CORESET #0 for monitoring PDCCH that schedules on-demand SIB1 is present.

For yet another instance, the UE can determine whether a CORESET #0 for monitoring PDCCH that schedules on-demand SIB1 is present (or whether the cell is associated with on-demand SIB1 for reception) based on a reserved bit in PBCH payload (e.g., spare). For instance, when the reserved bit in PBCH payload takes a particular value (e.g., 1), then its associated CORESET #0 for monitoring PDCCH that schedules on-demand SIB1 is present.

For yet another instance, the UE can determine whether a CORESET #0 for monitoring PDCCH that schedules on-demand SIB1 is present (or whether the cell is associated with on-demand SIB1 for reception) based on a value of k_SSB. For instance, the k_SSB value can be determined from a SSB (e.g., SSB associated with the same cell or carrier or bandwidth part as the on-demand SSB). For another instance, the k_SSB value can be provided by higher layer parameters (e.g., such as system information from a same gNB that transmits the on-demand SSB or from a different gNB that transmits the on-demand SSB).

For one instance, for FR1, if k_SSB=30, the UE can assume its associated CORESET #0 for monitoring PDCCH that schedules on-demand SIB1 can be present if requested by the UE (or the cell is associated with on-demand SIB1 for reception), and/or its associated CORESET #0 for monitoring PDCCH that schedules periodic SIB1 is not present. The UE may send a request for the on-demand SIB1.

For another instance, for FR2, if k_SSB=14, the UE can assume its associated CORESET #0 for monitoring PDCCH that schedules on-demand SIB1 can be present if requested by the UE (or the cell is associated with on-demand SIB1 for reception), and/or its associated CORESET #0 for monitoring PDCCH that schedules periodic SIB1 is not present. The UE may send a request for the on-demand SIB1.

For yet another instance, for FR1, if k_SSB≥24 (or 24≤k_SSB≤29, or k_SSBϵ{24, 25, 26, 27, 28, 29, 31}), the UE (e.g., that supporting the feature of on-demand SSB) can assume its associated CORESET #0 for monitoring PDCCH that schedules on-demand SIB1 can be present if requested by the UE (or the cell is associated with on-demand SIB1 for reception) and/or its associated CORESET #0 for monitoring PDCCH that schedules periodic SIB1 is not present. For one further consideration, the instance can be applicable when the frequency location of the on-demand SIB1 does not correspond to a synchronization raster entry.

For yet another instance, for FR2, if k_SSB≥12 (or 12≤k_SSB≤13, or k_SSBϵ{12, 13, 15}), the UE (e.g., that supporting the feature of on-demand SSB) can assume its associated CORESET #0 for monitoring PDCCH that schedules on-demand SIB1 can be present if requested by the UE (or the cell is associated with on-demand SIB1 for reception) and/or its associated CORESET #0 for monitoring PDCCH that schedules periodic SIB1 is not present. For one further consideration, the instance can be applicable when the frequency location of the on-demand SIB1 does not correspond to a synchronization raster entry.

For yet another instance, the UE can determine whether a CORESET #0 for monitoring PDCCH that schedules on-demand SIB1 is present (or whether the cell is associated with on-demand SIB1 for reception) based on reinterpreting a field or a bit in the PBCH payload.

For one instance, the field in the PBCH payload can be subCarrierSpacingCommon.

For another instance, the bit in the PBCH payload can be one bit from systemFrameNumber, e.g., the MSB or LSB of systemFrameNumber.

For yet another instance, the bit in the PBCH payload can be one bit from ssb-SubcarrierOffset, e.g., the MSB or LSB of ssb-SubcarrierOffset.

For yet another instance, the bit in the PBCH payload can be one bit from pdcch-ConfigSIB1 (e.g., one bit from controlResourceSetZero or one bit from searchSpaceZero).

For yet another instance, the bit in the PBCH payload can be the physical layer bit indicating half frame index.

For yet another instance, the bit in the PBCH payload can be one bit from physical layer bits indicating the SS/PBCH block index.

For yet another instance, the UE can determine whether a CORESET #0 for monitoring PDCCH that schedules on-demand SIB1 is present (or whether the cell is associated with on-demand SIB1 for reception) based on a combination of a value of k_SSB of a SSB and an indication by higher layer parameters, wherein the value of k_SSB can be from one instance of this embodiment, and the indication by higher layer parameters can be from another instance of this embodiment.

In one embodiment, a UE can determine a SCS for on-demand SIB1, wherein the SCS is applicable at least to the PDCCH that schedules on-demand SIB1 (e.g., the SCS for CORESET #0) and/or the PDSCH that carries the on-demand SIB1. For one further consideration, the SCS can be also applicable to the PDCCH in common search space, e.g., if not re-configured in system information.

For one example, the SCS for the on-demand SIB1 can be indicated to the UE by subCarrierSpacingCommon in the MIB of the associated SSB, e.g., on-demand SSB, and/or periodic SSB in the same cell.

For another example, the UE can assume that the SCS for the on-demand SIB1 is same as the SCS of the associated SSB, e.g., on-demand SSB, and/or periodic SSB in the same cell.

For yet another example, the UE can assume that the SCS for the on-demand SIB1 is same as the SCS of the active BWP (e.g., active DL BWP) that the UE is configured.

For yet another example, the UE can assume that the SCS for the on-demand SIB1 is same as the SCS of the legacy SSB (e.g., periodic SSB) in the same cell, or in the same frequency layer, or in the same active BWP (e.g., active DL BWP).

For yet another example, the UE can assume that the SCS for the on-demand SIB1 is same as the SCS of the CORESET #0 in the same cell, or in the same frequency layer, or in the same active BWP.

For yet another example, the UE can assume that the SCS for the on-demand SIB1 is same as the SCS of the DL trigger.

For yet another example, the UE can assume that the SCS for the on-demand SIB1 is same as the SCS of the UL trigger (e.g., UL request).

For yet another example, the UE can be provided with the SCS for the on-demand SIB1 by an indication in the DL trigger that triggers the transmission of on-demand SSB and/or on-demand SIB1.

For yet another example, the UE can be provided with the SCS for the on-demand SIB1 by an indication in the UL trigger that triggers the transmission of on-demand SSB and/or on-demand SIB1.

For yet another example, the UE can be provided an indication on the SCS for the on-demand SIB1 by higher layer parameters. For one instance, the higher layer parameters can include system information from a gNB that does not perform the transmission of on-demand SSB or on-demand SIB1 on the cell (e.g., the system information may include other configurations on the on-demand SSB or the on-demand SIB1 as well). For another instance, the higher layer parameters can include system information from a gNB that performs the transmission of on-demand SSB or on-demand SIB1 on the cell (e.g., the system information may include other configurations on the on-demand SSB or the on-demand SIB1 as well).

In one embodiment, a UE can determine a set of configurations for CORESET #0 to monitor PDCCH that schedules the on-demand SIB1.

For one example, the set of configurations for CORESET #0 can be indicated to the UE by (e.g., controlResourceSetZero in) the MIB of a SSB, e.g., the associated on-demand SSB, and/or the associated SSB on the same cell (e.g., periodic SSB).

For another example, the UE can assume that the set of configurations for CORESET #0 are same as the set of configurations for the CORESET #0 in the same cell, or in the same frequency layer, or in the same active BWP. For one further consideration, the set of configurations for the CORESET #0 in the same cell, or in the same frequency layer, or in the same active BWP can be provided by a SSB on the same cell, e.g., an on-demand SSB or periodic SSB on the same cell.

For yet another example, the UE can assume that the set of configurations for CORESET #0 is same as the set of configurations for CORESET to monitor the DL trigger.

For yet another example, the UE can be provided with the set of configurations for CORESET #0 by an indication in the DL trigger that triggers the transmission of on-demand SSB and/or on-demand SIB1.

For yet another example, the UE can be provided with the set of configurations for CORESET #0 by an indication in the UL trigger that triggers the transmission of on-demand SSB and/or on-demand SIB1.

For yet another example, the UE can be provided with at least one configuration content in the set of configurations for CORESET #0 by higher layer parameters. For one instance, the higher layer parameters can include system information from a gNB that does not perform the transmission of on-demand SSB or on-demand SIB1 on the cell (e.g., the system information may include other configurations on the on-demand SSB or on-demand SIB1 as well). For one further consideration of this instance, when the higher layer parameters are from the gNB that does not perform the transmission of on-demand SSB or on-demand SIB1 on the cell, the UE can use a SSB on the cell (e.g., periodic SSB (e.g., which indicates the cell is associated with on-demand SSB) or on-demand SSB) as a reference to determine frequency domain or time domain configuration of the CORESET #0 (such as the frequency domain offset). For another instance, the higher layer parameters can include system information from a gNB that performs the transmission of on-demand SSB or on-demand SIB1 on the cell (e.g., the system information may include other configurations on the on-demand SSB or on-demand SIB1 as well).

For one example, a configuration in the set of configurations for CORESET #0 includes a multiplexing pattern between SSB and its associated CORESET #0 for on-demand SIB1, wherein the multiplexing pattern can be configured as one from Pattern 1, or Pattern 2, or Pattern 3.

For another example, a configuration in the set of configurations for CORESET #0 includes a bandwidth of the CORESET #0 (e.g., in the unit of RBs), wherein the bandwidth of the CORESET #0 can be configured as one from 24 RBs, 48 RB, or 96 RBs.

For yet another example, a configuration in the set of configurations for CORESET #0 includes a number of OFDM symbols for CORESET #0, wherein the number of OFDM symbols for CORESET #0 can be configured as one from 1, 2, or 3.

For one example, there could be a further restriction on a configuration in the set of configurations such that the combination of the bandwidth of the CORESET #0 and the number of OFDM symbols for CORESET #0 is restricted, such as (N_BW, N_symb) is configurable from (24, 2), (24, 3), (48, 1), (48, 2), (48, 3), (96, 1), or (96, 2), wherein N_BW is the bandwidth of the CORESET #0, and N_symb is the number of OFDM symbols for CORESET #0.

For yet another example, a configuration in the set of configurations for CORESET #0 includes a frequency domain offset (e.g., in the unit of RBs), wherein the frequency domain offset refers to the difference from the smallest RB index of the CORESET #0 to the smallest RB index of the common RB overlapping with the first RB of the corresponding SS/PBCH block (e.g., on-demand SS/PBCH block, or periodic SS/PBCH block in the same cell).

For one instance, the frequency domain offset can be fixed as 0 (e.g., aligned at the lowest RB), e.g., the frequency domain offset in all configurations within the set of configurations is 0.

For another instance, the frequency domain offset can be fixed as N_BW-N_SSB (e.g., aligned at the highest RB), wherein N_BW is the bandwidth of the CORESET #0, and N_SSB is the bandwidth of SSB (e.g., in the number of RBs, such as 20 RBs), e.g., the frequency domain offset in all configurations within the set of configurations is determined as N_BW-N_SSB.

For another instance, the frequency domain offset can be fixed as (N_BW-N_SSB)/2 (e.g., aligned in the center), wherein N_BW is the bandwidth of the CORESET #0, and N_SSB is the bandwidth of SSB (e.g., in the number of RBs, such as 20 RBs), e.g., the frequency domain offset in all configurations within the set of configurations is determined as (N_BW−N_SSB)/2.

For yet another instance, the frequency domain offset can be configurable between 0 and N_BW−N_SSB.

For yet another instance, the frequency domain offset can be configurable among 0, (N_BW−N_SSB)/2, and N_BW−N_SSB.

For yet another example, a configuration in the set of configurations for CORESET #0 includes a frequency domain offset (e.g., in the unit of RBs), wherein the frequency domain offset refers to the difference from the smallest RB index of the CORESET #0 to the smallest RB index of the common RB overlapping with the first RB of a SS/PBCH block transmitted on the same cell or same BWP (e.g., an on-demand SS/PBCH block, or periodic SS/PBCH block in the same cell).

For one instance, the frequency domain offset can be fixed as 0 (e.g., aligned at the lowest RB), e.g., the frequency domain offset in all configurations within the set of configurations is 0.

For another instance, the frequency domain offset can be fixed as N_BW−N_SSB (e.g., aligned at the highest RB), wherein N_BW is the bandwidth of the CORESET #0, and N_SSB is the bandwidth of SSB (e.g., in the number of RBs, such as 20 RBs), e.g., the frequency domain offset in all configurations within the set of configurations is determined as N_BW−N_SSB.

For another instance, the frequency domain offset can be fixed as (N_BW-N_SSB)/2 (e.g., aligned in the center), wherein N_BW is the bandwidth of the CORESET #0, and N_SSB is the bandwidth of SSB (e.g., in the number of RBs, such as 20 RBs), e.g., the frequency domain offset in all configurations within the set of configurations is determined as (N_BW-N_SSB)/2.

For yet another instance, the frequency domain offset can be configurable between 0 and N_BW−N_SSB.

For yet another instance, the frequency domain offset can be configurable among 0, (N_BW−N_SSB)/2, and N_BW−N_SSB.

For yet another example, a configuration in the set of configurations for CORESET #0 includes a frequency domain offset (e.g., in the unit of RBs), wherein the frequency domain offset refers to the difference from the smallest RB index of the CORESET #0 to the smallest RB index of the CORESET for monitoring the DL trigger.

For one instance, the frequency domain offset can be fixed as 0.

In one embodiment, a UE can determine a set of configurations for the search space set of Type0-PDCCH that schedules the on-demand SIB1.

For one example, the set of configurations for the search space set of Type0-PDCCH can be indicated to the UE by (e.g., searchSpaceZero in) the MIB of a SSB, e.g., the associated on-demand SSB, and/or the associated SSB on the same cell.

For another example, the UE can assume that the set of configurations for the search space set of Type0-PDCCH are same as the set of configurations for the search space set of Type0-PDCCH in the same cell, or in the same frequency layer, or in the same active BWP. For one further consideration, the set of configurations for the CORESET #0 in the same cell, or in the same frequency layer, or in the same active BWP can be provided by a SSB on the same cell, e.g., an on-demand SSB or periodic SSB on the same cell.

For yet another example, the UE can assume that the set of configurations for the search space set of Type0-PDCCH is same as the set of configurations for search space set to monitor the DL trigger.

For yet another example, the UE can assume that reception occasions according to the set of configurations for the search space set of Type0-PDCCH has a time domain offset to the reception occasions according to the set of configurations for search space set to monitor the DL trigger.

For one instance, the time domain offset can be fixed.

For another instance, the time domain offset can be configured.

For yet another example, the UE can be provided with the set of configurations for the search space set of Type0-PDCCH by an indication in the DL trigger that triggers the transmission of on-demand SSB and/or on-demand SIB1.

For yet another example, the UE can be provided with the set of configurations for the search space set of Type0-PDCCH by an indication in the UL trigger that triggers the transmission of on-demand SSB and/or on-demand SIB1.

For yet another example, the UE can be provided with at least one configuration content in the set of configurations for the search space set of Type0-PDCCH by higher layer parameters. For instance, the higher layer parameters can include system information from a gNB that does not perform the transmission of on-demand SSB or on-demand SIB1 on the cell (e.g., the system information may include other configurations on the on-demand SSB or on-demand SIB1 as well). For one further consideration of this instance, when the higher layer parameters are from the gNB that does not perform the transmission of on-demand SSB or on-demand SIB1 on the cell, the UE can use a SSB on the cell (e.g., periodic SSB (e.g., which indicates the cell is associated with on-demand SSB) or on-demand SSB) as a reference to determine frequency domain or time domain configuration of the CORESET #0 (such as the periodicity or OFDM symbol or time offset). For another instance, the higher layer parameters can include system information from a gNB that performs the transmission of on-demand SSB or on-demand SIB1 on the cell (e.g., the system information may include other configurations on the on-demand SSB or on-demand SIB1 as well).

For one instance, the at least one configuration content can be a periodicity for monitoring occasions in the search space set.

For another instance, the at least one configuration content can be a number of the monitoring occasions or a number of bursts of monitoring occasions in the search space set.

For yet another instance, the at least one configuration content can be a number of the monitoring occasions corresponding to different SSBs in a burst (e.g., a number of SSB indexes correspondingly).

For yet another instance, the at least one configuration content can be a SSB index such that the UE can monitoring the Type0-PDCCH according to the configured SSB index.

For one example, a configuration in the set of configurations for the search space set of Type0-PDCCH can include a periodicity for the monitoring occasions in the search space set.

For another example, a configuration in the set of configurations for the search space set of Type0-PDCCH does not explicitly include a periodicity for the monitoring occasions in the search space set, and the UE assumes the periodicity for the monitoring occasions in the search space set is same as a periodicity of the corresponding SSB (e.g., on-demand SS/PBCH block, or periodic SS/PBCH block in the same cell).

For yet another example, a configuration in the set of configurations for the search space set of Type0-PDCCH can include a time domain offset for determining the monitoring occasions in the search space set.

For one instance, the time domain offset is determined with respect to an absolute timing, e.g., starting of a frame.

For another instance, the time domain offset is determined with respect to the timing of the on-demand SS/PBCH block, e.g., the starting of a frame or a half frame or a slot wherein the on-demand SS/PBCH block burst start to transmit.

For yet another example, a configuration in the set of configurations for the search space set of Type0-PDCCH may not explicitly include a time domain offset for determining the monitoring occasions in the search space set, and the UE can assume the monitoring occasion in the search space set is in the same slot as the corresponding SSB (e.g., on-demand SS/PBCH block, or periodic SS/PBCH block in the same cell).

For yet another example, a configuration in the set of configurations for the search space set of Type0-PDCCH may not explicitly include a time domain offset for determining the monitoring occasions in the search space set, and the UE can assume the monitoring occasions in the search space set start from the same slot or frame or half frame as the corresponding SSB transmission burst (e.g., on-demand SS/PBCH block, or periodic SS/PBCH block in the same cell).

For yet another example, a configuration in the set of configurations for the search space set of Type0-PDCCH can include a starting OFDM symbol in a slot for the monitoring occasions in the search space set.

For yet another example, the starting OFDM symbol in a slot for the monitoring occasions in the search space set can be fixed, such as symbol #0 if i_SSB mod 2=0, and symbol #7 if i_SSB mod 2=1, wherein i_SSB is the SS/PBCH block index.

For yet another example, a configuration in the set of configurations for the search space set of Type0-PDCCH can include a number of the monitoring occasions or a number of bursts of monitoring occasions in the search space set.

For yet another example, a configuration in the set of configurations for the search space set of Type0-PDCCH can include a number of the monitoring occasions corresponding to different SSBs in a burst (e.g., a number of SSB indexes correspondingly).

For yet another example, a configuration in the set of configurations for the search space set of Type0-PDCCH can include a SSB index such that the UE can monitor the Type0-PDCCH according to the SSB index.

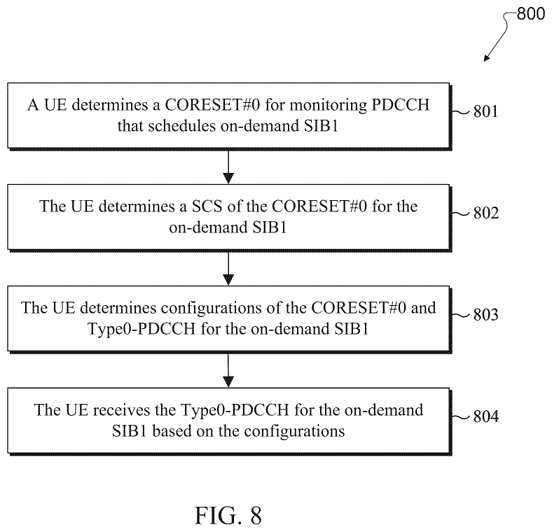

FIG. 8 illustrates a flowchart of UE method 800 for receiving on-demand SIB1 according to embodiments of the present disclosure. The UE method 800 as may be performed by a UE (e.g., 111-116 as illustrated in FIG. 1). An embodiment of the UE method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

In one embodiment, an example UE procedure for receiving on-demand SIB1 is shown in FIG. 8.

As illustrated in FIG. 8, in step 801, a UE determines a CORESET #0 for monitoring PDCCH. In step 802, the UE determines a SCS of the CORESET #0 for the on-demand SIB1. In step 803, the UE determines configurations of the CORESET #0 and Type0-PDCCH for the on-demand SB1. In step 804, the UE receivers the Type0-PDCCH for the on-demand SIB1 based on the configurations.

In one embodiment, a UE can determine a value of k_SSB that can be used to determine the common resource grid for CORESET #0 that is associated with the on-demand SIB1.

For one example, the value of k_SSB can be indicated to the UE by PBCH payload of the associated SSB, e.g., on-demand SSB, and/or periodic SSB in the same cell. For instance, the indication can be by using ssb-SubcarrierOffset in FR2, or by using combination of ssb-SubcarrierOffset and a physical layer bit in FR1.

For another example, the UE can assume that the value of k_SSB is determined based on the common resource grid.

For yet another example, the UE can be provided with the value of k_SSB by an indication in the DL trigger that triggers the transmission of on-demand SSB and/or on-demand SIB1.

For yet another example, the UE can be provided with the value of k_SSB by an indication in the UL trigger that triggers the transmission of on-demand SSB and/or on-demand SIB1.

For yet another example, the UE can be provided an indication the value of k_SSB by higher layer parameters. For one instance, the higher layer parameters can include system information from a gNB that does not perform the transmission of on-demand SSB or on-demand SIB1 on the cell (e.g., the system information may include other configurations on the on-demand SSB or on-demand SIB1 as well). For one further consideration of this instance, when the higher layer parameters are from the gNB that does not perform the transmission of on-demand SSB or on-demand SIB1 on the cell, the UE can use a SSB on the cell (e.g., periodic SSB (e.g., which indicates the cell is associated with on-demand SSB) or on-demand SSB) as a reference to determine the value of k_SSB. For another instance, the higher layer parameters can include system information from a gNB that performs the transmission of on-demand SSB or on-demand SIB1 on the cell (e.g., the system information may include other configurations on the on-demand SSB or on-demand SIB1 as well).

In one embodiment, k_SSB value can be adjusted based on whether the on-demand SIB1 is transmitted or not (e.g., whether a CORESET #0 for monitoring PDCCH that schedules on-demand SIB1 (or SIB1) is present or not). For instance, k_SSB value is used for indicating whether the on-demand SIB1 (or SIB1) is present (e.g., whether a CORESET #0 for monitoring PDCCH that schedules on-demand SIB1 (or SIB1) is present), according to examples of this disclosure.

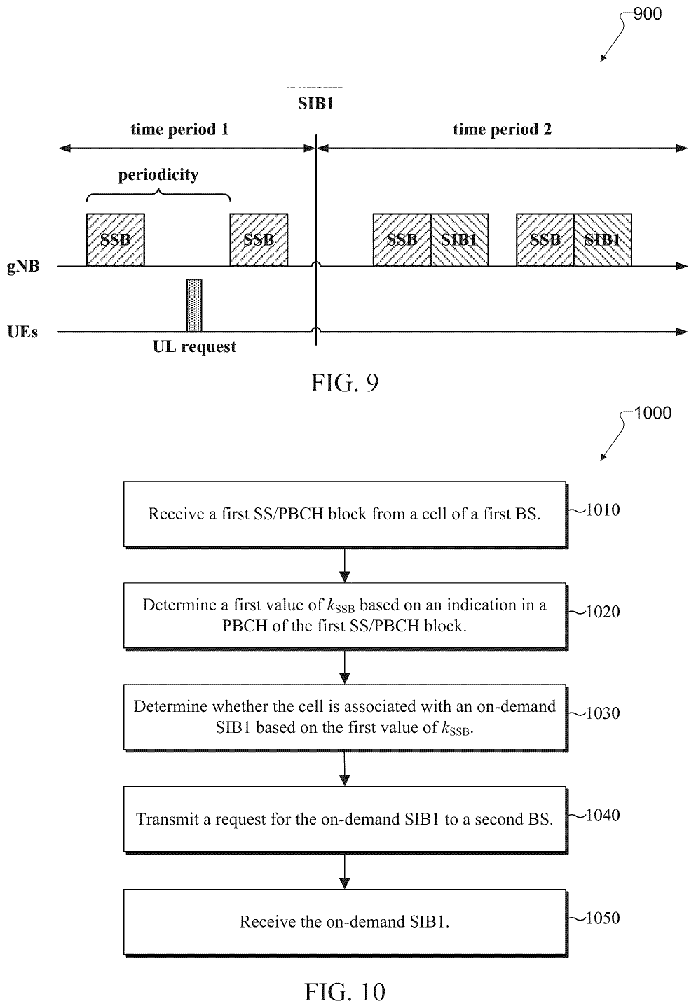

FIG. 9 illustrates an example of k_SSB switching 900 according to embodiments of the present disclosure. An embodiment of the k_SSB switching 900 shown in FIG. 9 is for illustration only.

For one example, for the time period where on-demand SIB1 is not transmitted (or no SIB1 is transmitted, or CORESET #0 for monitoring PDCCH that schedules on-demand SIB1 (or SIB1) is not present) (e.g., time period 1 in FIG. 9), when a UE receives a SSB (e.g., a periodic SSB), the UE can assume the k_SSB value is indicating a first value, which corresponds to that the on-demand SIB1 (or SIB1) is not present (e.g., a CORESET #0 for monitoring PDCCH that schedules on-demand SIB1 (or SIB1) is not present, or the cell is associated with on-demand SIB1 for the UE to request).

For another example, for the time period where on-demand SIB1 is transmitted (or SIB1 is transmitted, or CORESET #0 for monitoring PDCCH that schedules on-demand SIB1 (or SIB1) is present) (e.g., time period 2 in FIG. 9), when a UE receives a SSB (e.g., a periodic SSB), the UE can assume the k_SSB value is indicating a second value, which corresponds to that the on-demand SIB1 (or SIB1) is present (e.g., a CORESET #0 for monitoring PDCCH that schedules on-demand SIB1 (or SIB1) is present).

For yet another example, the boundary between time period 1 and time period 2 (including from time period 1 to time period 2, and/or from time period 2 to time period 1) can be a slot boundary.

For yet another example, the boundary between time period 1 and time period 2 (including from time period 1 to time period 2, and/or from time period 2 to time period 1) can be a slot boundary, wherein the slot boundary is aligned with a start of a half frame, and the half frame corresponds to the first half frame in the periodicity of the SSB.

For yet another example, the boundary between time period 1 and time period 2 (including from time period 1 to time period 2, and/or from time period 2 to time period 1) can be a slot boundary, wherein the slot boundary is aligned with a start of a half frame, and the half frame corresponds to the first half frame in the periodicity of the SIB1.

For yet another example, the boundary between time period 1 and time period 2 (including from time period 1 to time period 2, and/or from time period 2 to time period 1) can be corresponding to a start (or an end) of a TTI of the SSB transmission (e.g., TTI of the PBCH in the SSB).

For yet another example, the boundary between time period 1 and time period 2 (including from time period 1 to time period 2, and/or from time period 2 to time period 1) can be corresponding to a start (or an end) of a TTI of the SIB1 transmission.

FIG. 10 illustrates an example method 1000 performed by a UE in a wireless communication system according to embodiments of the present disclosure. The method 1000 of FIG. 10 can be performed by any of the UEs 111-116 of FIG. 1, such as the UE 116 of FIG. 3, and a corresponding method can be performed by any of the BSs 101-103 of FIG. 1, such as BSs 102 and 103 of FIG. 1. The method 1000 is for illustration only and other embodiments can be used without departing from the scope of the present disclosure.

The method 1000 begins with the UE a first SS/PBCH block from a cell of a first BS (1010). The UE then determines a first value of k_{SSB} based on an indication in a PBCH of the first SS/PBCH block (1020). The UE then determines whether the cell is associated with an on-demand SIB1 based on the first value of k_{SSB} (1030). For example, in 1030, the cell is associated with the on-demand SIB1 when the first value of k_{SSB} is 30 for FR1 or 14 for FR2.

The UE then determines transmits a request for the on-demand SIB1 to a second BS (1040). For example, in 1040, the determination is made based on a determination in 1030 that the cell is associated with the on-demand SIB1. The first BS and the second BS are different.

The UE then receives the on-demand SIB1. (1050). In various embodiments, the UE may also determine a set of configurations for receiving the on-demand SIB1. The set of configurations include a SCS value for the on-demand SIB1, a configuration for a CORESET #0, and a configuration for a Type0-PDCCH. The set of configurations is determined from i higher layer parameters from the second BS or ii a PBCH of a second SS/PBCH block received from the cell of the first BS.

In various embodiments, the UE may also receive, from the cell of the first BS, a second SS/PBCH block; determine, based on an indication in a PBCH of the second SS/PBCH block, a second value of k_{SSB}; and determine, based on the second value of k_{SSB} a presence of a CORESET #0 for monitoring a Type0-PDCCH that schedules the on-demand SIB1. In some examples, the second value of k_{SSB} is between 0 to 23 for FR1 or between 0 to 11 for FR2.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive, from a cell of a first base station (BS), a first synchronization signals and physical broadcast channel (SS/PBCH) block; and
a processor operably coupled to the transceiver, the processor configured to:
determine, based on an indication in a physical broadcast channel (PBCH) of the first SS/PBCH block, a first value of k_{SSB}; and
determine, based on the first value of k_{SSB}, whether the cell is associated with an on-demand system information block 1 (SIB1),
wherein the transceiver is further configured to:
transmit, based on a determination that the cell is associated with the on-demand SIB1, a request for the on-demand SIB1 to a second BS; and
receive the on-demand SIB1.

2. The UE of claim 1, wherein the cell is associated with the on-demand SIB1 when the first value of k_{SSB} is 30 for a frequency range 1 (FR1) or 14 for a frequency range 2 (FR2).

3. The UE of claim 1, wherein the first BS and the second BS are different.

4. The UE of claim 1, wherein:
the transceiver is further configured to receive, from the cell of the first BS, a second SS/PBCH block; and
the processor is further configured to:
determine, based on an indication in a PBCH of the second SS/PBCH block, a second value of k_{SSB}; and
determine, based on the second value of k_{SSB}, a presence of a control resource set #0 (CORESET #0) for monitoring a type 0 physical downlink control channel (Type0-PDCCH) that schedules the on-demand SIB1.

5. The UE of claim 4, wherein:
the second value of k_{SSB} is between 0 to 23, for a frequency range 1 (FR1), or between 0 to 11, for a frequency range 2 (FR2).

6. The UE of claim 1, wherein:
the processor is further configured to determine a set of configurations for receiving the on-demand SIB1, and
the set of configurations include:
a subcarrier spacing value for the on-demand SIB1;
a configuration for a control resource set #0 (CORESET #0); and
a configuration for a type 0 physical downlink control channel (Type0-PDCCH).

7. The UE of claim 6, wherein the set of configurations is determined from (i) higher layer parameters from the second BS or (ii) a PBCH of a second SS/PBCH block received from the cell of the first BS.

8. A method of a user equipment (UE) in a wireless communication system, the method comprising:
receiving, from a cell of a first base station (BS), a first synchronization signals and physical broadcast channel (SS/PBCH) block;
determining, based on an indication in a physical broadcast channel (PBCH) of the first SS/PBCH block, a first value of k_{SSB};
determining, based on the first value of k_{SSB}, whether the cell is associated with an on-demand system information block 1 (SIB1);
transmitting, based on a determination that the cell is associated with the on-demand SIB1, a request for the on-demand SIB1 to a second BS; and
receiving the on-demand SIB1.

9. The method of claim 8, wherein the cell is associated with the on-demand SIB1 when the first value of k_{SSB} is 30 for a frequency range 1 (FR1) or 14 for a frequency range 2 (FR2).

10. The method of claim 8, wherein the first BS and the second BS are different.

11. The method of claim 8, further comprising:
receiving, from the cell of the first BS, a second SS/PBCH block;
determining, based on an indication in a PBCH of the second SS/PBCH block, a second value of k_{SSB}; and
determining, based on the second value of k_{SSB}, a presence of a control resource set #0 (CORESET #0) for monitoring a type 0 physical downlink control channel (Type0-PDCCH) that schedules the on-demand SIB1.

12. The method of claim 11, wherein the second value of k_{SSB} is between 0 to 23, for a frequency range 1 (FR1), or between 0 to 11, for a frequency range 2 (FR2).

13. The method of claim 8, further comprising:
determining a set of configurations for receiving the on-demand SIB1, the set of configurations including:
a subcarrier spacing value for the on-demand SIB1;
a configuration for a control resource set #0 (CORESET #0); and
a configuration for a type 0 physical downlink control channel (Type0-PDCCH).

14. The method of claim 13, wherein the set of configurations is determined from higher layer parameters from the second BS or a PBCH of a second SS/PBCH block received from the cell of the first BS.

15. A base station (BS) in a wireless communication system, the BS comprising:
a processor configured to:
determine whether a cell is associated with an on-demand system information block 1 (SIB1); and
determine a first value of k_{SSB} when the cell is associated with the on-demand SIB1; and
a transceiver operably coupled to the processor, the transceiver configured to:
transmit, to a user equipment (UE), a first synchronization signals and physical broadcast channel (SS/PBCH) block, wherein a physical broadcast channel (PBCH) in the first SS/PBCH block indicates the first value of k_{SSB};
receive, from another BS, an indication for transmitting the on-demand SIB1; and
transmit, to the UE, the on-demand SIB1 in the cell.

16. The BS of claim 15, wherein the first value of k_{SSB} is 30 for a frequency range 1 (FR1) or 14 for a frequency range 2 (FR2).

17. The BS of claim 15, wherein the BS and the other BS are different.

18. The BS of claim 15, wherein:
the processor is further configured to:
determine a presence of a control resource set #0 (CORESET #0) for monitoring a type 0 physical downlink control channel (Type0-PDCCH) that schedules the on-demand SIB1; and
determine a second value of k_{SSB}, wherein the second value of k_{SSB} is between 0 to 23, for a frequency range 1 (FR1), or between 0 to 11, for a frequency range 2 (FR2); and
the transceiver is further configured to transmit, to the UE, a second SS/PBCH block, wherein the PBCH in the second SS/PBCH block indicates the second value of k_{SSB}.

19. The BS of claim 15, wherein the processor is further configured to:
determine a set of configurations for the on-demand SIB1, the set of configurations including:
a subcarrier spacing value for the on-demand SIB1;
a configuration for a control resource set #0 (CORESET #0); and
a configuration for a type 0 physical downlink control channel (Type0-PDCCH).

20. The BS of claim 19, wherein the set of configurations is determined from higher layer parameters from the other BS or a PBCH of a second SS/PBCH block transmitted from the cell of the BS.
